(19) United States
(12) Patent Application Publication
(10) Pub. No.: US 2026/0020086 A1
(43) Pub. Date: Jan. 15, 2026

(54) METHODS AND PROCESSORS FOR PROXIMITY-BASED DEVICE COLLABORATION

(71) Applicant: HUAWEI TECHNOLOGIES CO., LTD., Shenzhen (CN)

(72) Inventors: Qiang XU, Richmond Hill (CA); Chenhe LI, Richmond Hill (CA); Xuehan YE, Richmond Hill (CA); Nu ZHANG, Richmond Hill (CA); Zhuang SHEN, Xi'an (CN); Xu CHEN, Nanjing (CN)

(21) Appl. No.: 18/767,511

(22) Filed: Jul. 9, 2024

(51) Int. Cl. H04W 76/14; G06F 3/16; H04W 4/02

(52) U.S. Cl. CPC H04W 76/14; G06F 3/162; H04W 4/02

(57) ABSTRACT

Methods and electronic devices for proximity-based collaboration are disclosed. The method includes monitoring proximity between the first device and the second device using a proximity sensor, triggering, based on information received from the proximity sensor, use of communication hardware to detect proximity between the first device and the second device, where the communication hardware has a comparatively higher power consumption to the proximity sensor, and in response to detecting proximity using the communication hardware, establishing a connection between the first device and the second device. This may allow for lower overall power consumption.

### FIELD

The present technology relates generally to proximity-based device collaboration, and more specifically, methods and processors for interaction between a first electronic device and a second electronic device.

### BACKGROUND

There are many scenarios where “in-person” or “proximity-based” data sharing is desirable. One known example of proximity-based data sharing between devices is AirDrop™ technology. This feature allows Apple™ devices to wirelessly share files using Bluetooth™ and Wi-Fi™ modalities. Broadly, this technology allows the devices to detect each other when they are in close proximity, and the user can select the recipient from a list of nearby devices. The recipient can then accept or decline the file transfer.

A first way to implement proximity-based data sharing is to use QR codes. QR technologies allow the sender to select content they want to share, click a “share content” button, selects the “QR code” option, and display the QR code to the recipient's phone. The recipient can open the camera app and scans the QR code. QR technologies generally involve many steps.

A second way to implement proximity-based data sharing is to use Bluetooth Low Energy (BLE) communication. BLE is a wireless technology that operates in the 2.4 GHz frequency band and uses less power than regular Bluetooth™. BLE data share allows devices to find each other, pair, and send files over BLE without needing physical contact or Wi-Fi™ connection. BLE data sharing technologies generally involve many steps to start the transfer, have low range and speed, and can be affected by other devices.

A third way to implement proximity-based data sharing is to use Ultra-wideband (UWB) technology. UWB is a wireless technology that can send data across a range of frequency bands. UWB can allow devices in close proximity to sense each other's location and share data. The devices can automatically recognize each other, establish a connection, and send the data without needing user input or pairing process. The electronic devices require additional hardware for employing the UWB technology. A UWB chipset is usually integrated into a smartphone, for example, to interact with nearby devices.

A third way to implement proximity-based data sharing is to use Near Field Communication (NFC) technology. NFC is a wireless technology that allows communication over a short range between compatible devices. NFC data sharing technologies allow sharing files between two devices that support NFC by bringing them near each other or touching them. The devices can exchange data without needing network connection. The electronic devices require additional hardware for employing the NFC technology. A NFC antenna is usually integrated into a smartphone, for example, to interact with nearby devices. Furthermore, location of NFC antennas on electronic devices may vary from one device to another.

There is a need for new solutions for proximity-based data sharing.

### SUMMARY

Developers have devised methods and processors for overcoming at least some drawbacks present in prior art solutions. Developers have realized that solutions for triggering proximity-based data sharing may be desired for reducing power consumption. Developers have realized that solutions for triggering proximity-based data sharing may be desired for increasing energy efficiency of the device.

NFC proximity-based solutions have some drawbacks. For example, using NFC antennas may be ill-suited for triggering sharing due to different relative locations of NFC antenna on different devices. Location of an NFC antenna on a given device may be limited by an internal design of a given device, and these designs vary from one device manufacturer to another. Other known solutions may require other additional equipment/hardware (e.g., UWB) to trigger proximity-based data sharing, which increases the production cost of such devices and increases the power consumption of such devices.

In the context of the present technology, there is provided a proximity-based data sharing solution for exchanging data between a first device and a second device. Broadly, when a first device phone partially overlaps a second device, sensors of the devices can detect proximity of the two devices. In one embodiment, a magnetometer within a speaker of a given device may be used to detect proximity of the two devices. Developers have realized that a magnetic field change, due to a speaker of a top device being superimposed over a speaker of a bottom device, can be detected by the magnetometer(s) in the top speaker and/or in the bottom speaker. It should be noted that speakers on electronic devices are often located near the top edge of the device making them well-suited for overlapping gestures.

In some embodiments of the present technology, proximity detection may be performed using at least one of a measure of magnetic field change, a measure of wireless path loss (for example, txPower−RSSI), and a measure from a light sensor. Additionally, or alternatively, a given proximity sensor and/or a given light sensor may be used to determine which device is a top device, and which device is a bottom device, in addition to detecting proximity, during the overlapping gesture.

In response to detecting proximity between the two devices, the devices are configured to establish a wireless connection and trigger subsequent functions. A variety of communication modalities may be used for executing subsequent functions. Some functions include, but are not limited to, sharing content, sharing application stream, sharing network, and the like.

Developers of the present technology have devised methods, electronic devices and systems for monitoring and detecting proximity between a pair of devices. It should be noted that a first low-consumption hardware (e.g., a proximity sensor) may be used for monitoring for proximity. Once the first low-consumption hardware determines a potential proximity between a pair of devices, a second comparatively high-consumption hardware may be triggered for further use. It is contemplated that the comparatively high-consumption hardware (such as communication hardware, for example) may be used for confirming the proximity between the pair of devices. It is contemplated that one or more high-consumption hardware components may be used for transmitting data between the pair of devices during the confirmation of proximity and/or may use one or more wireless communication protocols therefor.

In a first broad aspect of the present technology, there is provided a method for proximity-based collaboration between a first device and a second device. The method comprises: monitoring proximity between the first device and the second device using a proximity sensor; triggering, based on information received from the proximity sensor, use of communication hardware to detect proximity between the first device and the second device, the communication hardware having a comparatively higher power consumption to the proximity sensor; and in response to detecting proximity using the communication hardware, establishing a connection between the first device and the second device. This may allow for lower overall power consumption.

In some embodiments of the method, the proximity sensor is a light sensor of at least one of the first device and the second device.

In some embodiments of the method, the first proximity sensor is a magnetic sensor of at least one of the first device and the second device.

In some embodiments of the method, the triggering the use of the communication hardware comprises triggering wireless communication using at least one of a first wireless protocol and a second wireless protocol.

In some embodiments of the method, the communication hardware comprises Bluetooth-based hardware of at least one of the first device and the second device.

In some embodiments of the method, the communication hardware comprises Near Field Communication (NFC) hardware of at least one of the first device and the second device.

In some embodiments of the method, at least one of the first device and a second device is a smartphone.

In some embodiments of the method, the other one of the first device and the second device is a smartspeaker.

In some embodiments of the method, the method further comprises triggering transmission of data from one of the first device and the second device to the other one of the first device and the second device.

In some embodiments of the method, the data is at least one of textual data, audio data, and video data.

In a second broad aspect of the present technology, there is provided an electronic device comprising a processor, a proximity sensor and communication hardware. The processor is configured to: monitor proximity between the electronic device and an other electronic device using the proximity sensor; trigger, based on information received from the proximity sensor, use of the communication hardware to detect proximity between the electronic device and the other electronic device, the communication hardware having a comparatively higher power consumption to the proximity sensor; and in response to detecting proximity using the communication hardware, establishing a connection between the first device and the second device.

In some embodiments of the electronic device, the proximity sensor is a light sensor.

In some embodiments of the electronic device, the proximity sensor is a magnetic sensor.

In some embodiments of the electronic device, to trigger the use of the communication hardware comprises the processor configured to trigger wireless communication between the electronic device and the other electronic device using at least one of a first wireless protocol and a second wireless protocol.

In some embodiments of the electronic device, the communication hardware comprises Bluetooth-based hardware.

In some embodiments of the electronic device, the communication hardware comprises Near Field Communication (NFC) hardware.

In some embodiments of the electronic device, the electronic device is a smartphone.

In some embodiments of the electronic device, the other electronic device is a smartspeaker.

In some embodiments of the electronic device, the processor is further configured to trigger transmission of data from one of the electronic device and the other electronic device to the other one of the electronic device and the other electronic device.

In some embodiments of the electronic device, the data is at least one of textual data, audio data, and video data.

In a third broad aspect of the present technology, there is provided a non-transient computer readable medium containing program instructions for causing an electronic device to perform the method of: monitoring proximity between the electronic device and an other electronic device using a proximity sensor; triggering, based on information received from the proximity sensor, use of communication hardware to detect proximity between the electronic device and the other electronic device, the communication hardware having a comparatively higher power consumption to the proximity sensor; and in response to detecting proximity using the communication hardware, establishing a connection between the electronic device and the other electronic device.

In some embodiments of the non-transient computer readable medium, the proximity sensor is a light sensor of at least one of the electronic device and the other electronic device.

In some embodiments of the non-transient computer readable medium, the first proximity sensor is a magnetic sensor of at least one of the electronic device and the other electronic device.

In some embodiments of the non-transient computer readable medium, the triggering the use of the communication hardware comprises triggering wireless communication using at least one of a first wireless protocol and a second wireless protocol.

In some embodiments of the non-transient computer readable medium, the communication hardware comprises Bluetooth-based hardware of at least one of the electronic device and the other electronic device.

In some embodiments of the non-transient computer readable medium, the communication hardware comprises Near Field Communication (NFC) hardware of at least one of the electronic device and the other electronic device.

In some embodiments of the non-transient computer readable medium, at least one of the electronic device and the other electronic device is a smartphone.

In some embodiments of the non-transient computer readable medium, the other one of the electronic device and the other electronic device is a smartspeaker.

In some embodiments of the non-transient computer readable medium, the method further comprises triggering transmission of data from one of the electronic device and the other electronic device to the other one of the electronic device and the other electronic device.

In some embodiments of the non-transient computer readable medium, the data is at least one of textual data, audio data, and video data.

In another aspect, embodiments of this disclosure provide a computer readable storage medium, comprising one or more instructions, wherein when the one or more instructions are run on a computer, the computer performs any of the methods disclosed herein.

In another aspect, embodiments of this disclosure provide a device configured to perform any of the methods disclosed herein.

In another aspect, embodiments of this disclosure provide a processor, configured to execute instructions to cause a device to perform any of the methods disclosed herein.

In another aspect, embodiments of this disclosure provide an integrated circuit configure to perform any of the methods disclosed herein.

According to one aspect of this disclosure, there is provided a module comprising: one or more circuits for performing any of the methods disclosed herein.

According to one aspect of this disclosure, there is provided an apparatus comprising: one or more processors functionally connected to one or more memories for performing any of the methods disclosed herein.

According to one aspect of this disclosure, there is provided an apparatus configured to perform any of the methods disclosed herein.

In some embodiments the apparatus comprises one or more units configured to perform the above-described method.

According to one aspect of this disclosure, there is provided one or more non-transitory, computer-readable storage media comprising computer-executable instructions, wherein the instructions, when executed, cause at least one processing unit, at least one processor, or at least one circuits to perform any of the methods disclosed herein.

According to one aspect of this disclosure, there is provided one or more computer-readable storage media storing a computer program, wherein, when the computer program is executed by an apparatus, the apparatus is enabled to implement any of the methods disclosed herein.

According to one aspect of this disclosure, there is provided a computer program product including one or more instructions, wherein, when the instructions are executed by an apparatus, the apparatus is enabled to implement any of the methods disclosed herein.

According to one aspect of this disclosure, there is provided a computer program, wherein, when the computer program is executed by a computer, an apparatus is enabled to implement any of the methods disclosed herein.

In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system

In the context of the present specification, the expression “information” includes information of any nature or kind whatsoever capable of being stored in a database. Thus, information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates an example of a computing device that may be used to implement any of the methods described herein.

FIG. 2 illustrates hardware components of the first electronic device and the second electronic device of FIG. 3.

FIGS. 3A and 3B illustrate a “OneHop” gesture between a first electronic device and a second electronic device, in accordance with at least some non-limiting embodiments of the present technology.

FIGS. 4A, 4B, 4C, 4D, and 4E illustrate sequential positioning of the first electronic device relative to the second electronic device during a OneHop gesture.

FIG. 5 is a flowchart of a method for proximity-based device collaboration executable by the first electronic device and the second electronic device in accordance with at least some non-limiting embodiments of the present technology.

FIG. 6 is a sequence diagram of the method for proximity-based device collaboration of FIG. 5.

FIG. 7 is a flowchart of a method of performing context sharing over devices in accordance with a first embodiment of the present technology.

FIG. 8 is a flowchart of a method of enabling hotspot sharing over devices in accordance with a second embodiment of the present technology.

FIG. 9 is a flowchart of a method of enabling stream shearing over devices in accordance with a third embodiment of the present technology.

FIG. 10 is a scheme-block illustration of a method executed by a processor of the computing device of FIG. 1, in accordance with at least some non-limiting embodiments of the present technology.

FIG. 11 is a flowchart of a method for proximity-based device collaboration executable by a first electronic device and a second electronic device in accordance with at least some non-limiting embodiments of the present technology.

FIG. 12 is a sequence diagram of the method for proximity-based device collaboration of FIG. 11.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

### Computer System

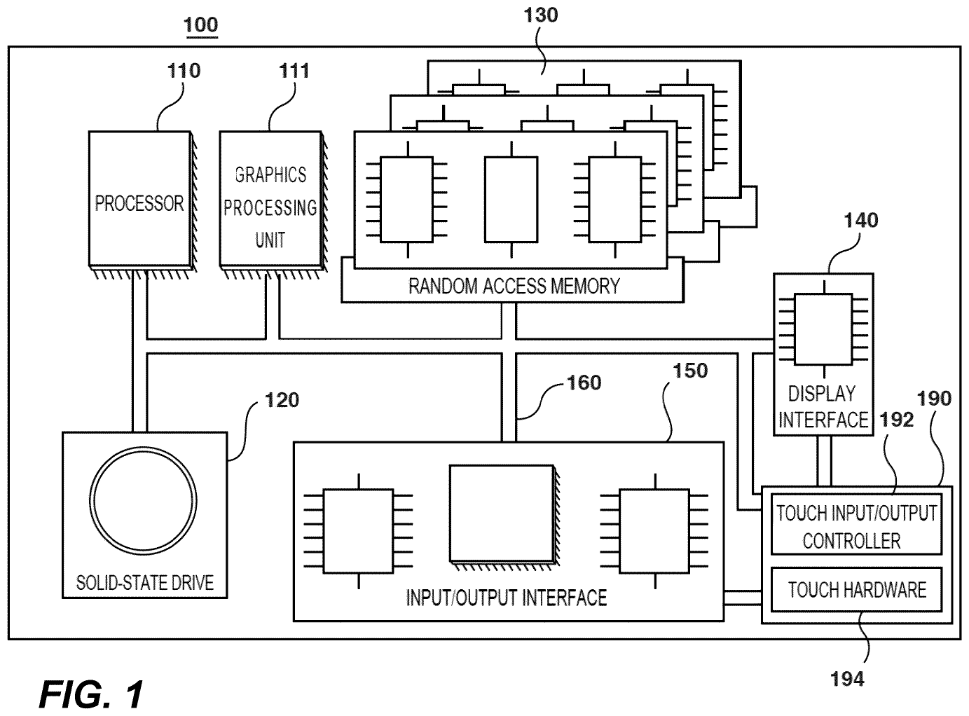

With reference to FIG. 1, there is depicted a computer system 100 suitable for use with some implementations of the present technology. The computer system 100 comprises various hardware components including one or more single or multi-core processors collectively represented by a processor 110, a graphics processing unit (GPU) 111, a solid-state drive 120, a random-access memory 130, a display interface 140, and an input/output interface 150.

According to implementations of the present technology, the solid-state drive 120 stores program instructions suitable for being loaded into the random-access memory 130 and executed by the processor 110 and/or the GPU 111. For example, the program instructions may be part of a library or an application.

Communication between the various components of the computer system 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. It is noted some components of the computer system 100 can be omitted in some non-limiting embodiments of the present technology. For example, the keyboard and the mouse (both not separately depicted) can be omitted, especially (but not limited to) where the computer system 100 is implemented as a compact electronic device, such as the smartwatch or a smartphone for example.

Broadly speaking, the touchscreen 190 may comprise touch hardware 194 and a touch input/output controller 192 allowing communication with the display interface 140 and/or the one or more internal and/or external buses 160. For example, the touch hardware 194 may comprise pressure-sensitive cells embedded in a layer of a display allowing detection of a physical interaction between a user and the display.

### Electronic Device

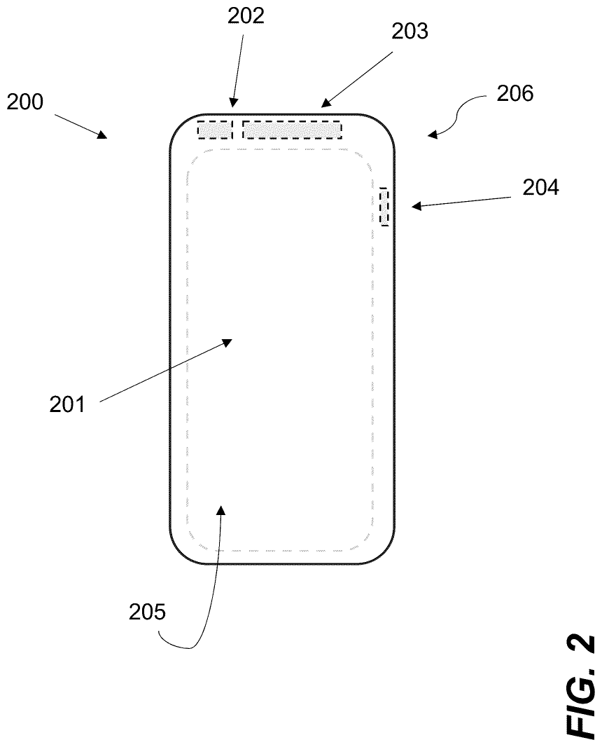

With reference to FIG. 2, there is depicted a simplified representation of an electronic device 200. It is contemplated that the electronic device 200 may comprise one or more components of the computer system 100 illustrated in FIG. 1, without departing from the scope of the present technology. In this embodiment, the electronic device 200 is a smartphone, however, this might not be the case in each and every embodiment of the present technology.

In FIG. 2, a front side 205 of the electronic device 200 is shown with a touchscreen 201. The electronic device 200 comprises a first sensor 202, a second sensor 203, and a third sensor 204, and which are located near an upper end 206 of the electronic device 200. The sensors 202 to 204 may comprise a variety of sensors.

In some embodiments, at least one of the sensors 202 to 204 may comprise a light sensor. A light sensor on a smartphone is a device that measures the ambient light level and adjusts the brightness of the display accordingly. The light sensor can help to optimize the readability of the screen and conserve battery power by reducing the backlight intensity when the surrounding light is sufficient. The light sensor can also be used to enable or disable certain features, such as automatic night mode or adaptive color temperature. The light sensor can be a front facing sensor, located near the top of the phone.

In some embodiments, at least one of the sensors 202 to 204 may comprise a Bluetooth antenna. A Bluetooth antenna on a smartphone is a device that enables wireless communication and data transfer with other Bluetooth-enabled devices, such as headphones, speakers, keyboards, or smartwatches. The Bluetooth antenna can be used to pair the phone with compatible devices and stream audio, video, or other data over short distances. The Bluetooth antenna can also be used to share files, contacts, or photos with nearby phones or tablets. The Bluetooth antenna can be an internal component, embedded in the phone's circuit board or casing. The Bluetooth antenna can be a rear facing sensor, located near the bottom of the phone.

In some embodiments, at least one of the sensors 202 to 204 may comprise a WI-FI antenna. A WI-FI antenna on a smartphone is a device that enables wireless communication and data transfer with other devices that are connected to the same local area network (LAN), such as routers, modems, laptops, or printers. The WI-FI antenna can be used to access the internet, browse websites, stream online content, download files, or send and receive emails. The WI-FI antenna can be an internal component, embedded in the phone's circuit board or casing.

In some embodiments, at least one of the sensors 202 to 204 may comprise a BLE antenna. A BLE antenna on a smartphone is a device that enables low-energy wireless communication and data transfer with other devices that support BLE technology, such as smartwatches, fitness trackers, headphones, or keyboards. The BLE antenna can be used to pair the smartphone with compatible devices, exchange information, control settings, or stream audio. The BLE antenna can be an internal component, embedded in the phone's circuit board or casing, or an external component, attached to the phone's headphone jack or charging port.

In some embodiments, at least one of the sensors 202 to 204 may comprise a speaker. A speaker on a smartphone is a device that converts electrical signals into sound waves that can be heard by the user or other people nearby. The speaker can be used to play music, podcasts, videos, or other audio content, as well as to make phone calls, use voice assistants, or listen to alerts and notifications. The speaker can be an internal component, embedded in the phone's circuit board or casing, or an external component, attached to the phone's headphone jack or charging port. The speaker includes magnets that create a magnetic field that interacts with a coil of wire and a diaphragm to produce vibrations that generate sound. The speaker can be a front facing speaker, located on the front side of the phone near the earpiece, or a bottom facing speaker, located on the bottom edge of the phone near the microphone. The speaker can have different sizes, shapes, and power ratings, depending on the design and specifications of the phone. The speaker includes magnets.

In some embodiments, at least one of the sensors 202 to 204 may comprise a magnetometer. A magnetometer on a smartphone is a device that measures the strength and direction of the magnetic field around the phone. The magnetometer can be used to determine the orientation of the phone relative to the Earth's magnetic north, which enables applications such as navigation, compass, or augmented reality. The magnetometer can also detect the presence of other magnetic sources, such as magnets, speakers, or RFID tags, which can be used for data transfer, authentication, or proximity sensing. The magnetometer can be an internal component, embedded in the phone's circuit board or casing. The magnetometer includes a sensor that consists of a coil of wire or a Hall effect element that generates a voltage when exposed to a magnetic field. The voltage can be measured and converted into a digital signal that represents the magnitude and direction of the magnetic field. The magnetometer can have different sensitivities, resolutions, and ranges, depending on the design and specifications of the phone.

In some embodiments, at least one of the sensors 202 to 204 may comprise a proximity sensor. A proximity sensor on a smartphone is a device that detects the presence of nearby objects without physical contact. The proximity sensor can be used to turn off the touchscreen and dim the display when the user holds the phone near their ear during a call, to prevent accidental touches and save battery power. The proximity sensor can also be used to activate certain gestures or features, such as waving a hand over the phone to silence an alarm or answer a call. The proximity sensor can be a front facing sensor, located near the top of the phone. The proximity sensor can be a front facing proximity sensor.

It is contemplated that a proximity sensor may be embodied in a variety of ways. However, the proximity sensor is configured to detect and/or sense the approach or presence of nearby objects without necessarily requiring physical contact. It is contemplated that a proximity sensor may be embodied as at least one of: (i) an ambient light sensor, (ii) a photoelectric proximity sensor, and (iii) a ultrasonic proximity sensor. In at least one embodiment, the proximity sensor may be a capacitive sensor that is configured to detect proximity of metallic objects and nonmetallic objects. In one other embodiment, the proximity sensor may be a photoelectric sensor using a light source and a receiver component for detecting proximity of objects via a change of a light signal. In one further embodiment, the proximity sensor may be a magnetic sensor including an electrical switch that is operable based on the presence of permanent magnets in a sensing area. In one additional embodiment, the proximity sensor may be an ultrasonic proximity sensor configured to detect a change in ultrasonic waves for detecting proximity of objects.

### Overlapping Gesture

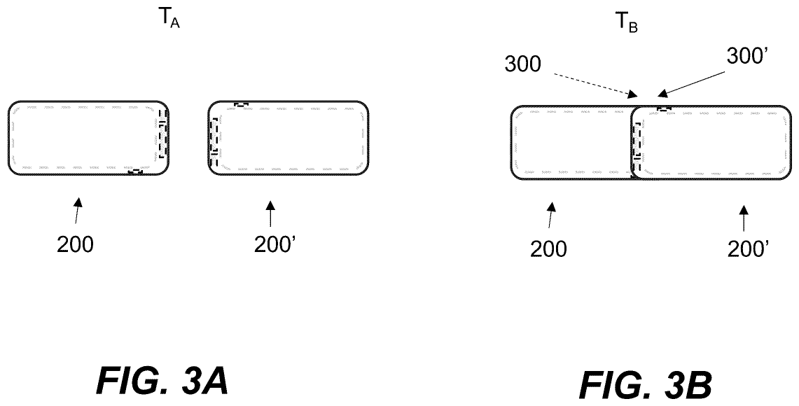

With reference to FIGS. 3A and 3B, there is depicted a simplified representation of a gesture that can be performed by users for triggering proximity-based data sharing between the electronic device 200 and another electronic device 200′. As it will become apparent from the description herein further below, an “overlapping” gesture refers to a gesture where a user brings one device in proximity to another device, such that one of these devices is overlapping, at least partially, the other one of these devices.

As seen in FIG. 3A, at T_{A}, the electronic device 200 and the other electronic device 200′ are close to one another but do not overlap. For example, at T_{A}, the electronic device 200 and the other electronic device 200′ may be at least 10 cm away from each other. As seen in FIG. 3B, at T_{B}, the electronic device 200 and the other electronic device 200′ are brought closer together and now partially overlap. In this example, a portion 300 of the electronic device 200 is overlapped by a portion 300′ of the other electronic device 200′. In another example, the portion 300′ of the other electronic device 200′ can be overlapped by the portion 300 of the electronic device 200, without departing from the scope of the present technology.

Developers have realized that, at T_{B}, information generated by a magnetometer and/or a light sensor of the device 200 may be used by the processor 110 of the device 200 to determine that the device 200 is being overlapped by the other device 200′. It is contemplated that in some embodiments, in response to the processor 110 of at least one of the devices determining that the corresponding device is being overlapped and/or is overlapping another device, the processor 110 of the at least one of the devices may trigger one or more actions.

Developers have realized that, at T_{B}, a magnetometer of the electronic device 200 and a magnetometer of the other electronic device 200′ can observe synchronous magnetic field change. It is contemplated that in some embodiments, in response to the processor 110 of at least one of the devices 200 and 200′ detecting a magnetic field change, the processor 110 may trigger one or more actions.

In this example, at T_{B}, it should be noted that Bluetooth antennas of the device 200 and of the other device 200′ may be located at a distance of 3 cm away from each other. The Bluetooth signal path loss (TxPower−RSSI) may quickly increase when proximate devices move away from each other. A free space path loss model may estimate a path loss between the BLE antennas at 6 cm distance that is 9 dBm higher than a pathloss between the BLE antennas at 2 cm distance.

Developers of the present technology have realized that a top speaker and its magnetometer are often located near an upper end of a smartphone. When the two device 200 and 200′ overlap, the magnetometers on the two device 200 and 200′ may detect synchronous magnetic field change. In response to detecting a magnetic field change, a Bluetooth antenna may be used to detect an increase in RSSI during the overlap. This change in RSSI can be used to trigger one or more actions. Additionally or alternatively, a proximity sensor and/or a light sensor can be used to determine a directionality during the overlapping gesture—i.e., which device is overlapping and which device is being overlapped.

In other words, it can be said that information from a magnetometer (and/or of a light sensor) may be used by the processor 110 to determine that two devices are in an overlapping configuration. In response to determining that the two devices are in an overlapping configuration, the processor 110 may trigger a second modality. The second modality may include, but is not limited to: the Bluetooth antenna for determining the RSSI, UWB ranging, microwave ranging, and the like.

Developers have realized that using the second modality for continuously monitoring for proximity/overlap increases power consumption of the device. In contrast, in the context of the present technology, there are provided methods and processors where a first modality (e.g., magnetometer for determining magnetic field change and/or light sensor for determining light obstruction), which consumes comparatively less power than the second modality, is used for monitoring for overlap and then triggering use of the second modality only when the overlap is detected.

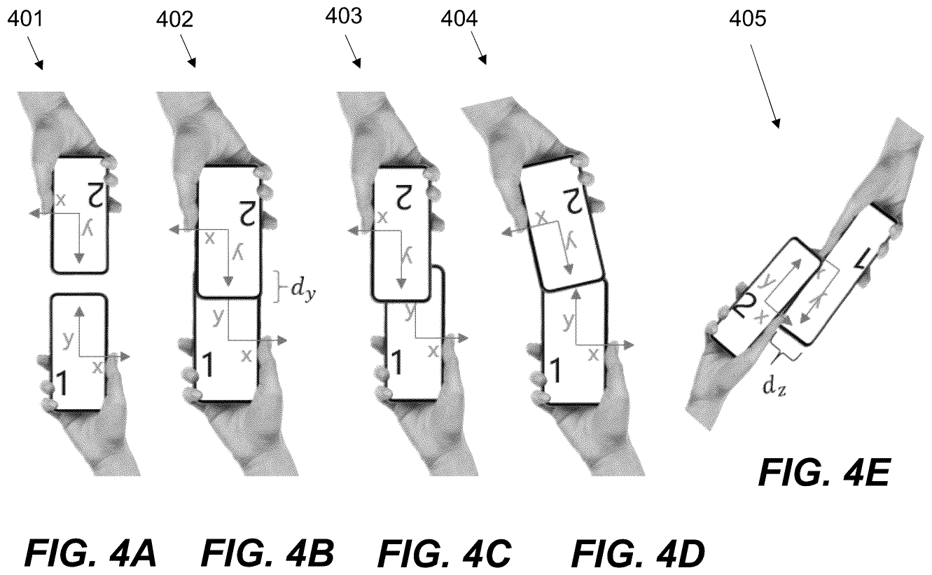

With reference to FIGS. 4A-4E, there is depicted a sequence of relative orientations of the device 200 and of the other device 200′ which are contemplated during an overlapping gesture in accordance with at least some embodiments of the present technology.

As seen in FIG. 4A, the devices 200 and 200′ are being approached. As seen in FIG. 4B, an overlap distance between the devices 200 and 200′ along y axis may be within an interval [a, b]. In one implementation, the boundary a may be 1 cm and the boundary b may be 4 cm. As seen in FIG. 4C, an overlap distance between the devices 200 and 200′ along x axis may be within an interval [0, c]. In one implementation, boundary c may be 3 cm. As seen in FIG. 4C, the devices 200 and 200′ may be rotated relative to one another in a plane extending along x and y axes and within an interval [d, e]. In one implementation, the boundary d may be 135 degrees and the boundary e may be 180 degrees. As seen in FIG. 4C, an overlap distance between the devices 200 and 200′ along x axis may be within an interval [0, f]. In one implementation, boundary f may be 2 cm. It should be expressly understood that boundaries of intervals may vary depending on inter alia various implementations of the present technology.

### Methods

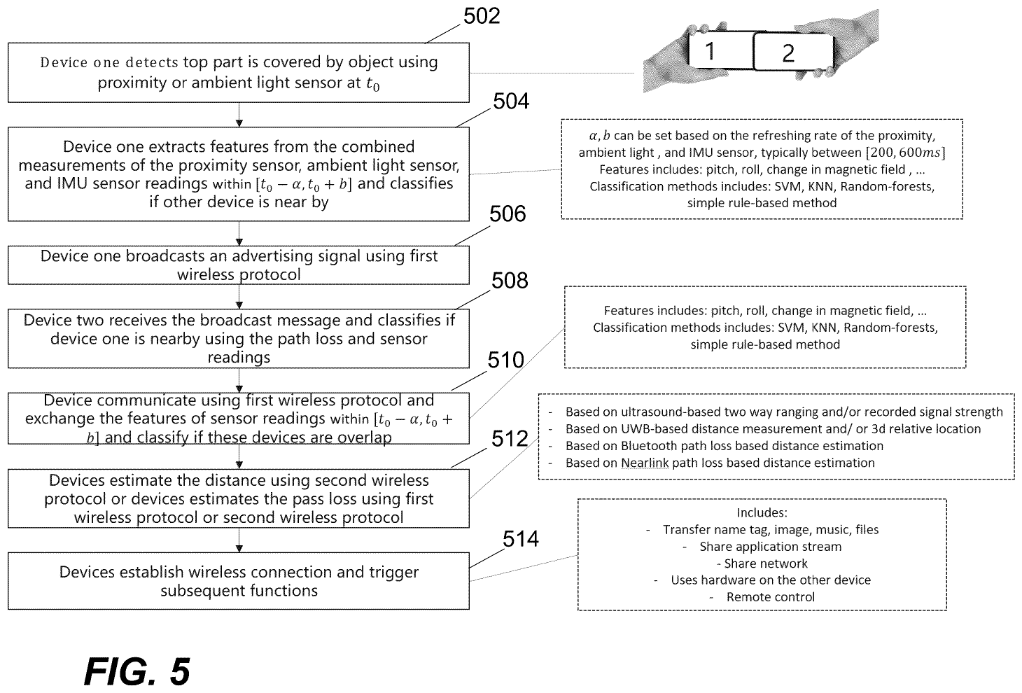

With reference to FIG. 5, there is depicted a method 500 executable by the device 200 and the other device 200′ during the gesture, in at least some embodiments of the present technology.

At step 502, the device 200 detects that it is partially overlapped by an object at to. In some embodiments, during the step 502, the processor 110 of the device 200 may acquire data from a proximity sensor of the device 200. In other embodiments, during the step 502, the processor 110 of the device 200 may acquire data from a light sensor of the device 200. In further embodiments, during the step 502, the processor 110 of the device 200 may acquire data from a magnetometer of the device 200. During the step 502, the processor 110 may use the received data (from the proximity sensor and/or the light sensor and/or the magnetometer thereof) to determine that the front side 205 of the device 200 is being covered by the object. In response to determining that the device 200 is partially overlapped by the object, the processor 110 may proceed to step 504.

At step 504, the device 200 extracts features from data received from a combination of at least some of the proximity sensor, the light sensor, the magnetometer, and the IMU sensor. The processor 110 of the device 200 is configured to use the extracted features to perform a classification task. The classification task results in a determination of whether the other device 200′ is in proximity.

In some embodiments, the features may be extracted for a period of time within an interval [t₀-α, t₀+β] where α and β can be values pre-determined based on a refreshing rate of at least one of the proximity sensor, the light sensor, the magnetometer, and the IMU sensor. In one implementation, the α and β values may be pre-determined as values between 200 ms and 600 ms.

In other embodiments, the features extracted by the processor 110 may comprise at least one of: a pitch, a roll, a change in magnetic field value, and the like. It is contemplated that the processor 110 may execute one or more classification models for performing the classification task. In some embodiments, the processor 110 may execute at least one of a SVM model, KNN model, Random-forest model, and a heuristic model.

At step 506, the device 200 broadcasts an advertising signal using a first wireless protocol. In some embodiments, the first wireless protocol may be a BLE-based protocol, a Nearlink-based protocol, and the like.

At step 508, the other device 200′ receives the broadcasted message and performs another classification task. The other classification task is used to determine whether the device 200 is nearby using a path loss and other sensor data.

At step 510, the devices 200 and 200′ communicate using the first wireless protocol and exchange features from sensor data (and/or the sensor data itself). A further classification task is then performed to determine if the two devices overlap.

In some embodiments, the features from the interval [t₀-α, t₀+β] can be exchanged. In other embodiments, the exchanged features may comprise at least one of: a pitch, a roll, a change in magnetic field value, and the like. It is contemplated that one or more classification models can be used for performing the classification task. In some embodiments, at least one of a Support Vector Machine (SVM) model, K-Nearest Neighbors (KNN) model, Random-Forest (RF) model, and a heuristic model may be used by the processor 110 for the classification task.

Generally speaking, a SVM model is a supervised learning model that can be used for binary or multiclass classification. The SVM model can be configured to determine a hyperplane that separates the data points of different classes with the maximum margin. The data points that are closest to the hyperplane are called support vectors and determine the optimal hyperplane. The SVM model can also use kernels to map the data points to a higher dimensional space where they are more linearly separable.

Generally speaking, A KNN model is a non-parametric learning model that can be used for classification or regression. The SVM model can be configured to determine k most similar data points (neighbors) to a new data point based on a distance metric, such as Euclidean distance, for example. The new data point is then assigned the class label or the average value of its neighbors. The KNN model does not require any training, but it can be computationally expensive to find the nearest neighbors for each new data point.

Generally speaking, an RF model is an ensemble learning model that can be used for classification or regression. It works by creating a large number of decision trees from randomly selected subsets of the training data, and then aggregating their predictions by voting (for classification) or averaging (for regression). The RF model can reduce the variance and overfitting of individual decision trees, and improve the accuracy and robustness of the model.

Generally speaking, a heuristic model is a rule-based or empirical model that can be used for classification. It works by applying a set of predefined rules or criteria to the data, or by using a simple formula or function to approximate the outcome.

At step 512, the devices estimate the distance using a second wireless protocol. It is contemplated that the devices estimate a path loss using the first wireless protocol or the second wireless protocol. For example, Ultrasound-based two way ranging and/or recorded signal strength, UVW-based distance measurement and/or 3D relative location, Bluetooth path loss based distance estimation, and Nearlink path loss based distance estimation may be performed. In one embodiment, only one of the devices may be configured to estimate the distance using the second wireless protocol. In other embodiments, both of the devices may be configured to estimate the distance using the second wireless protocol for security reasons.

Generally speaking, Ultrasound-based two way ranging is a method that uses an ultrasound transmitter and receiver on each device to measure the time of flight of an ultrasonic pulse between them. The distance is calculated from the speed of sound and the round-trip time. Alternatively, the signal strength of the received ultrasound signal can be used to estimate the distance based on a known attenuation model.

Generally speaking, UVW-based distance measurement is a method that uses an ultraviolet (UV) LED and a visible light (V) LED on each device, and a camera or photodiode (W) on the other device to measure the distance and angle between them. The distance is calculated from the ratio of the UV and V intensities, and the angle is calculated from the position of the LEDs on the image or the phase difference of the signals.

Generally speaking, Bluetooth path loss based distance estimation is a method that uses the Bluetooth Signal Strength Indicator (RSSI) and/or Received Channel Power Indicator (RCPI) to estimate the distance between the devices based on a known path loss model. The path loss model can account for the effects of obstacles, interference, and multipath fading on the signal propagation.

Generally speaking, Nearlink path loss based distance estimation is a method that uses the Nearlink protocol, which is a low-power, short-range wireless communication protocol that operates in the sub-GHz frequency band. The Nearlink protocol provides a RSSI or RCPI value for each packet transmission, which can be used to estimate the distance between the devices based on a known path loss model. The path loss model can also account for the effects of obstacles, interference, and multipath fading on the signal propagation.

At step 514, the devices 200 and 200′ establish wireless connection and trigger subsequent functions. It can be said that device 200 can establish connection with device 200′. It is contemplated that device 200′ can establish connection with device 200. At least one of the device 200 and 200′ may trigger one or more actions such as, for example, transferring name tag, image, music, other files, share application stream, share network, use hardware on the other device, and perform remote control.

### Communication Sequence

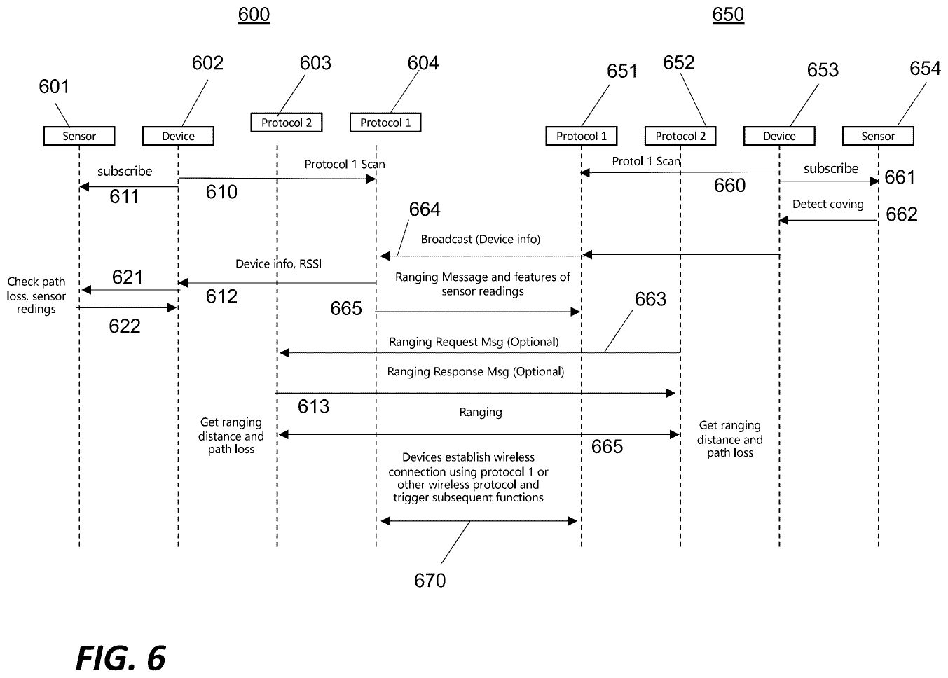

With reference to FIG. 6, there is depicted a communication sequence performed using a first electronic device 600 and a second electronic device 650. The first electronic device 600 comprises a device 602 processing line, a sensor 601 processing line, a protocol 2 603 processing line, and a protocol 1 604 processing line. The second electronic device 650 comprises a device 653 processing line, a sensor 654 processing line, a protocol 2 652 processing line, and a protocol 1 651 processing line. Various communication between processing lines of FIG. 6 will now be described.

At step 660, If the protocol 1 651 is enabled by the device 653, the device 653 may periodically scan for nearby devices. The nearby devices may be performing an “advertising” by emitting an advertising signal. This process of scanning for devices may be referred to as a “discovery” mode of the device 653.

At 610, If the protocol 1 604 is enabled by the device 602, the device 602 may periodically scan for nearby devices.

At step 661, the device 653 may register a “listener” for acquiring one or more values from an IMU sensor, an ambient light sensor, and/or any other proximity sensor at a relatively low sampling frequency. The sensors 654 may be configured to report one or more sensor readings to the device 653 (e.g., one or more processors thereof) according to sampling frequency or according to detection of an event. For example, a given proximity sensor may detect a proximity-type event.

At step 611, the device 602 may register a listener for acquiring one or more values from an IMU sensor, ambient light sensor, and/or any other proximity sensor at low sampling frequency. The sensors 601 may be configured to report one or more sensor readings to the device 602 (e.g., one or more processors thereof) according to sampling frequency or according to detection of an event.

At step 662, when the proximity sensor detects a cover event, a signal indicative of such as event may be reported to the device 653.

At step 664, the device 653 may be configured to broadcast the advertisement data which comprises the device information of the device 653.

At step 612, The protocol 1 604 may repot a scanning result comprising advertisement data and RSSI data. The device 602 may be configured to verify and/or compare values of the RSSI and recent sensor readings.

At step 621, the device 602 may be configured to request sensor data from the sensor 601. At step 622, the sensor 601 may provide requested data to the device 602.

At step 665, the device 602 may communicate using the protocol 1 with the device 653. In some embodiments, the devices may communicate using the first wireless protocol and exchange features from sensor data (and/or the sensor data itself) similar to what is described with reference to step 510 of FIG. 5.

At step 663, the device 653 may be configured to send a ranging request to the device 602. The device 653 may perform one way ranging using the second protocol 652. More than two messages similar to information from the step 512 of FIG. 5 may be generated in some embodiments of the present technology. In some embodiments, the step 663 may be optional.

At step 613, the device 653 may be configured to send a ranging response to the device 602. The device 653 may perform one way ranging using the second protocol 603. More than two messages similar to information from the step 512 of FIG. 5 may be generated in some embodiments of the present technology. In some embodiments, the step 613 may be optional.

At step 665, the devices 602 and 653 may acquire ranging distance and/or path loss data of the other one of the devices 602 and 653, respectively.

At step 670, the devices the devices 602 and 653 may establish a wireless connection using the protocol 1 or other wireless protocols. As a result, one or more subsequent functions as described herein may be triggered by at least one of the devices 602 and 653, without departing from the scope of the present technology.

In some embodiments, it can be said that during the communication sequence illustrated in FIG. 6, after the device 653 covers the device 602, device 653 detects the covering event using proximity sensor (e.g., an ambient light sensor and/or magnetic sensor) at t_0.

In some embodiments, it can be said that during the communication sequence illustrated in FIG. 6, the device 653 may extract features from a combination of measurements from a proximity sensor, an ambient light senor, an accelerometer, a magnetometer within readings within [t_0−α, t_0+b] and performs a classification task to determine if the device 602 is on top of it. α, b can be set based on the refreshing rate of one or more of the proximity sensor, ambient light sensor, and an IMU sensor. For example, the refresh rate may be between [200, 600 ms]. The extracted features may include, but are not limited to: a linear acceleration value, a gravity value, a pitch value, a roll value, a change in magnetic field, a change in ambient light brightness, and the like. Classification methods may make use of at least one of the following MLA architectures: SVM, KNN, Random-forests, and the like. A rule-based method may also be employed for classification purposes.

In some embodiments, it can be said that during the communication sequence illustrated in FIG. 6, the device 653 broadcasts an advertising signal using a first wireless protocol (e.g., Bluetooth low energy, Nearlink). The advertising signal may include device information (e.g., device ID, device MAC address, TxPower data).

In some embodiments, it can be said that during the communication sequence illustrated in FIG. 6, the device 602 may receive the broadcast message and performs a classification task to determine if the device 653 is nearby using the path loss value and sensor readings. Path loss may be embodied as TxPower−RSSI. Sensor readings may include at least one of linear acceleration value, gravity value, magnetic field change, change in ambient light brightness, and the like.

In some embodiments, it can be said that during the communication sequence illustrated in FIG. 6, one or more devices may use the first wireless protocol and exchange the features of sensor readings within [t_0−α, t_0+b] and classify if the one or more devices are at least partially overlapped.

In some embodiments, it can be said that during the communication sequence illustrated in FIG. 6, one or more devices may estimate the distance using the second wireless protocol. In other embodiments, it can be said that during the communication sequence illustrated in FIG. 6, one or more devices may estimate the pass loss using first wireless protocol and/or second wireless protocol. The path loss estimation may be performed via at least one of (i) ultrasound-based two way ranging, acoustic signal direction and/or recorded signal strength (ii) UWB-based two way ranging and/or 3d relative location, (iii) Bluetooth path loss (TxPower−RSSI) based distance estimation, (iv) Nearlink path loss (TxPower−RSSI) based distance estimation.

In some embodiments, it can be said that during the communication sequence illustrated in FIG. 6, one or more devices establish connection and trigger subsequence functions.

### Context Sharing Over Devices

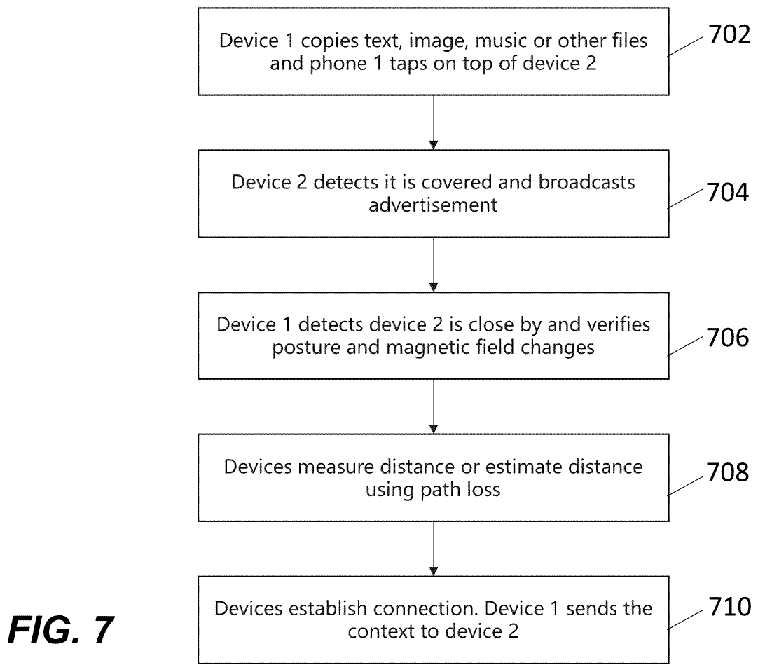

With reference to FIG. 7, there is depicted a method 700 for context sharing between devices in accordance with a first embodiment of the present technology.

During the step 702, a first device is configured to perform a copy operation on content, and the user may move the first device so as to partially overlap a second device.

During the step 704, the second device is configured to detect that it is partially covered using a proximity, ambient light sensor and/or a magnetometer. In response, the second device is configured to broadcast an advertisement signal.

During the step 706, the first device detects that the second device is close by using the advertisement signal. It is contemplated that the first device may be configured to use a second modality to detect the advertisement signal, and process the advertisement signal to determine proximity of the second device.

During the step 708, at least one of the first device and the second device is configured to determine a distance between each other.

During the step 710, the first device and the second device establish a connection for sharing the content over the connection.

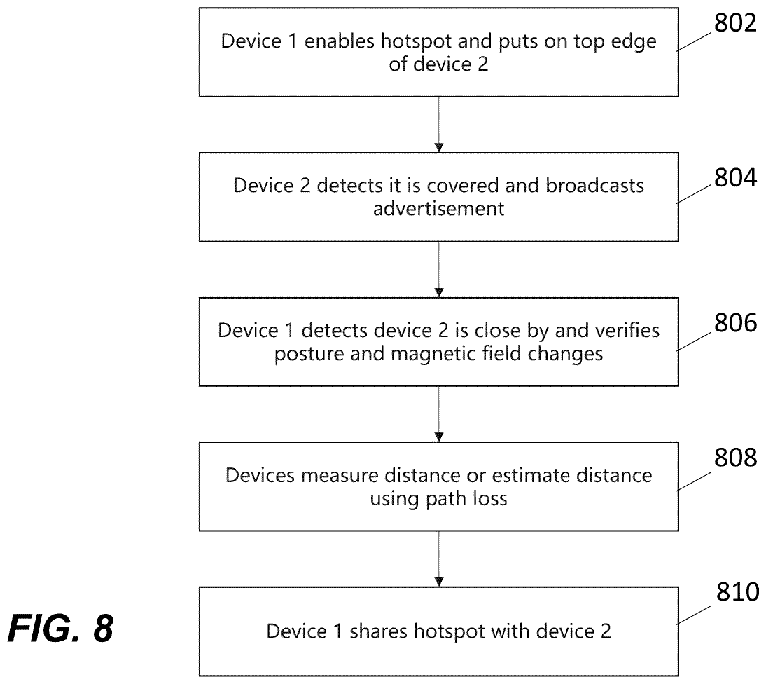

With reference to FIG. 8, there is depicted a method 800 for hotspot sharing between devices in accordance with a second embodiment of the present technology.

During the step 802, a first device activates its hotspot function, and the user may move the first device so as to partially overlap a second device.

During the step 804, the second device is configured to detect that it is partially covered using a proximity, ambient light sensor and/or a magnetometer. In response, the second device is configured to broadcast an advertisement signal.

During the step 806, the first device detects that the second device is close by using the advertisement signal. It is contemplated that the first device may be configured to use a second modality to detect the advertisement signal, and process the advertisement signal to determine proximity of the second device.

During the step 808, at least one of the first device and the second device is configured to determine a distance between each other.

During the step 810, the first device and the second device establish a connection for enabling hotspot sharing over the connection.

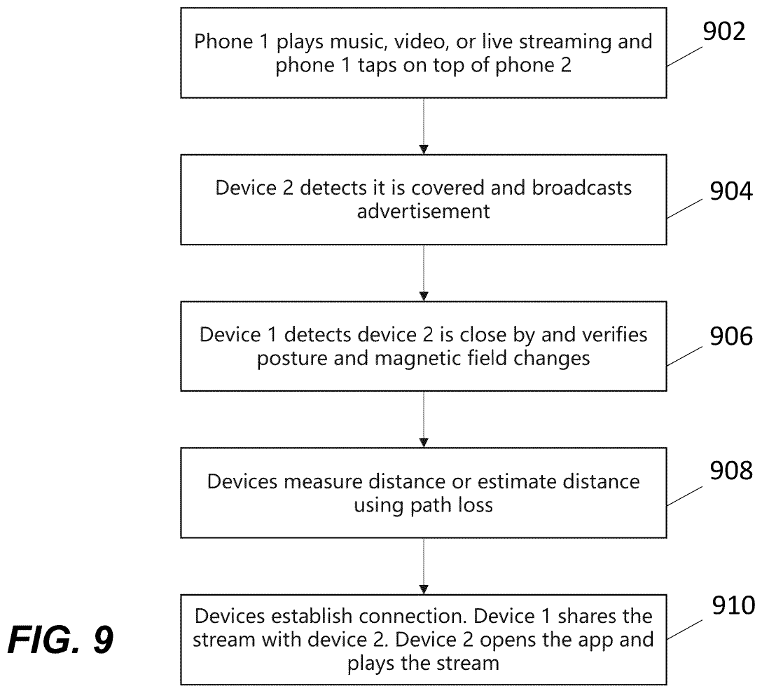

With reference to FIG. 9, there is depicted a method 900 for stream sharing between devices in accordance with a second embodiment of the present technology.

During the step 902, a first device is currently streaming content, and the user may move the first device so as to partially overlap a second device.

During the step 904, the second device is configured to detect that it is partially covered using a proximity, ambient light sensor and/or a magnetometer. In response, the second device is configured to broadcast an advertisement signal.

During the step 906, the first device detects that the second device is close by using the advertisement signal. It is contemplated that the first device may be configured to use a second modality to detect the advertisement signal, and process the advertisement signal to determine proximity of the second device.

During the step 908, at least one of the first device and the second device is configured to determine a distance between each other.

During the step 910, the first device and the second device establish a connection for the second device to launch an app and streams the same content over the connection.

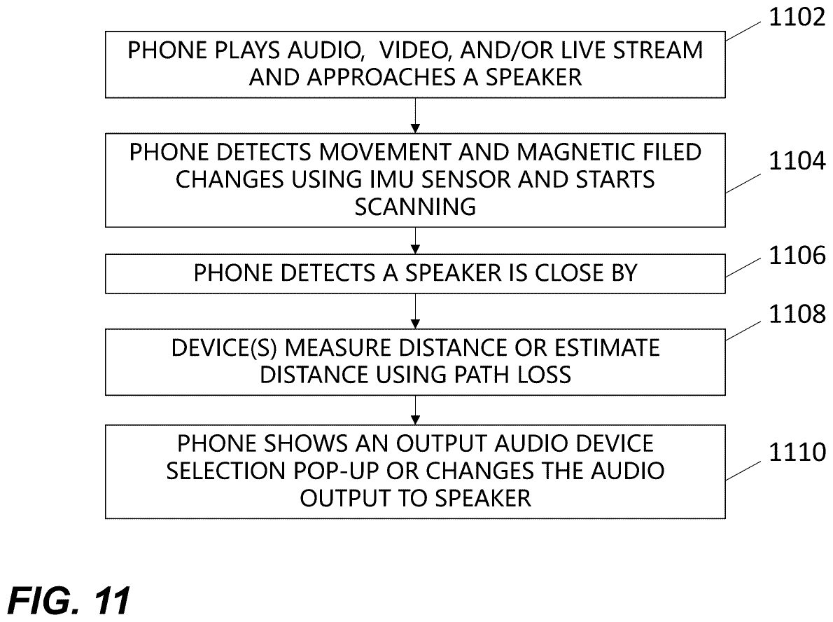

With reference to FIG. 11, there is depicted a method 1100 for stream sharing between devices in accordance with a fourth embodiment of the present technology.

At step 1102, a smartphone may play an audio, a video, and/or a live stream and approaches a speaker. At step 1104, the smartphone may detect movement and/or magnetic field change using inter alia an IMU sensor and triggers a scanning mode. At step 1106, the smartphone detects that the speaker is in proximity. At step 1108, one or both of the smartphone and the speaker are configured to measure distance and/or estimate distance using path loss. At step 1110, the smartphone displays an output audio device selection pop-up to a user thereof and/or changes the audio output to speaker instead of playing the audio output locally.

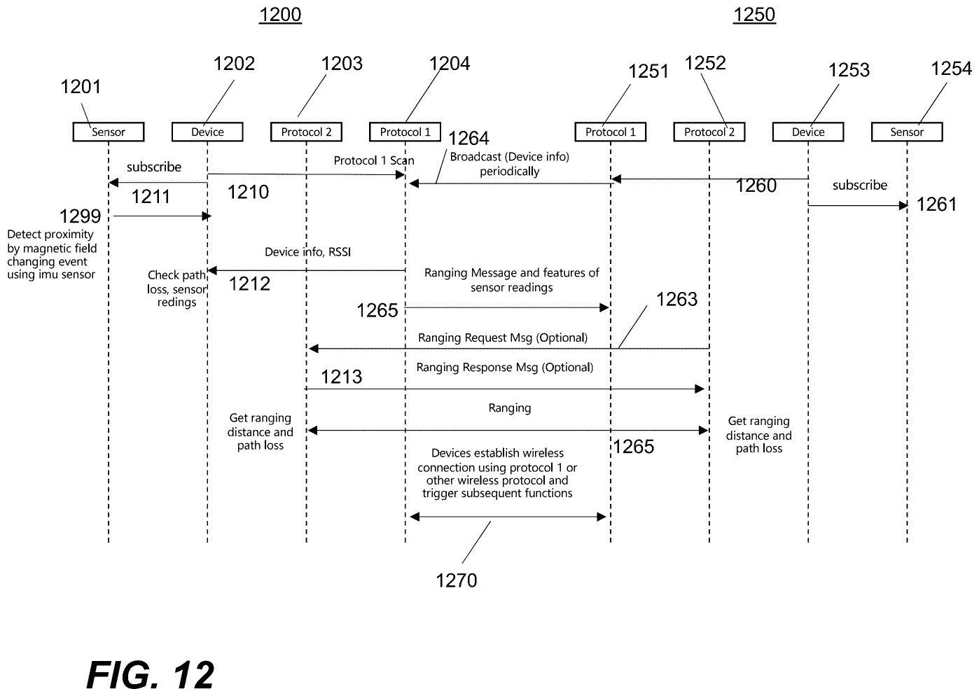

With reference to FIG. 12, there is depicted a communication sequence performed using a first electronic device 1200, where the device 1200 is a smartphone and a second electronic device 1250, where the device 1250 is a smart speaker, similar to the two devices performing the method 1100 of FIG. 11. The first electronic device 1200 comprises a device 1202 processing line, a sensor 1201 processing line, a protocol 2 1203 processing line, and a protocol 1 1204 processing line. The second electronic device 1250 comprises a device 1253 processing line, a sensor 1254 processing line, a protocol 2 1252 processing line, and a protocol 1 1251 processing line. Various communication between processing lines of FIG. 12 will now be described.

At step 1260, If the protocol 1 1251 is enabled by the device 1253, the device 1253 may periodically broadcast device info via one or more steps 1264.

At 1210, If the protocol 1 1204 is enabled by the device 1202, the device 1202 may periodically scan for nearby devices.

At step 1261, the device 1253 may register a “listener” for acquiring one or more values from an IMU sensor, an ambient light sensor, and/or any other proximity sensor at a relatively low sampling frequency. The sensors 1254 may be configured to report one or more sensor readings to the device 1253 (e.g., one or more processors thereof) according to sampling frequency or according to detection of an event. For example, a given proximity sensor may detect a proximity-type event.

At step 1211, the device 1202 may register a listener for acquiring one or more values from an IMU sensor, ambient light sensor, and/or any other proximity sensor at low sampling frequency. The sensors 1201 may be configured to report one or more sensor readings to the device 1202 (e.g., one or more processors thereof) according to sampling frequency or according to detection of an event.

At step 1299, when the proximity sensor detects a cover event, a signal indicative of such as event may be reported to the device 1202.

At step 1212, The protocol 1 1204 may repot a scanning result comprising advertisement data and RSSI data. The device 1202 may be configured to verify and/or compare values of the RSSI and recent sensor readings.

At step 1265, the device 1202 may communicate using the protocol 1 with the device 1253. In some embodiments, the devices may communicate using the first wireless protocol and exchange features from sensor data (and/or the sensor data itself).

At step 1263, the device 1253 may be configured to send a ranging request to the device 1202. The device 1253 may perform one way ranging using the second protocol 652. In some embodiments, the step 1263 may be optional.

At step 1213, the device 1253 may be configured to send a ranging response to the device 1202. The device 1253 may perform one way ranging using the second protocol 1203. In some embodiments, the step 1213 may be optional.

At step 1265, the devices 1202 and 1253 may acquire ranging distance and/or path loss data of the other one of the devices 1202 and 1253, respectively.

At step 1270, the devices the devices 1202 and 1253 may establish a wireless connection using the protocol 1 or other wireless protocols. As a result, one or more subsequent functions as described herein may be triggered by at least one of the devices 1202 and 1253, without departing from the scope of the present technology.

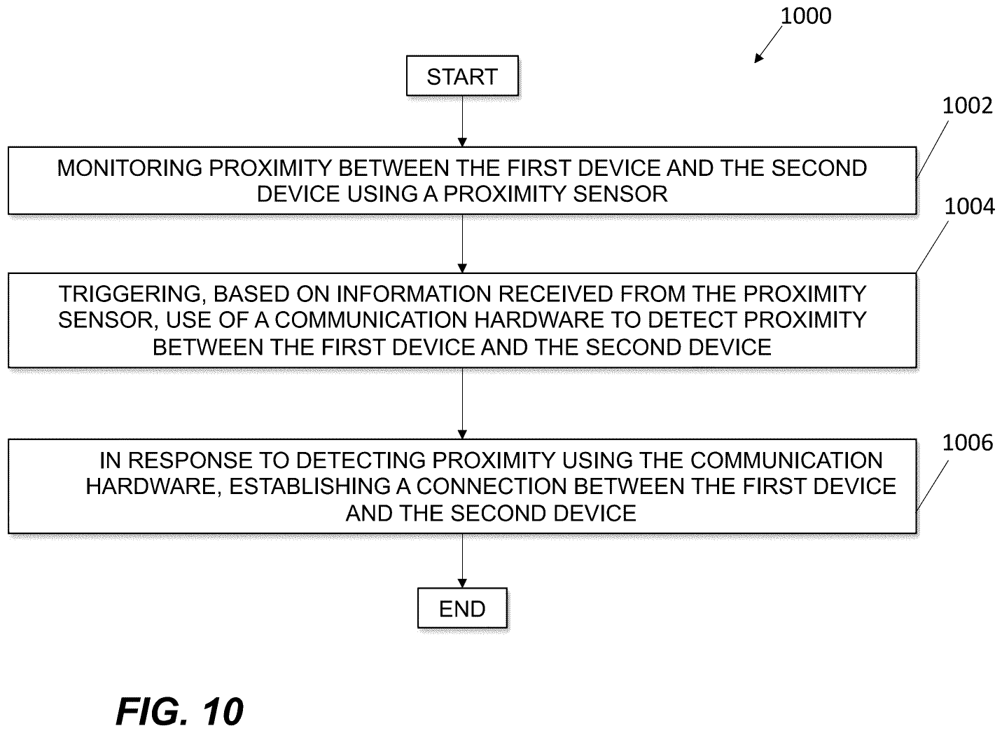

With reference to FIG. 10, there is depicted a scheme-block illustration of a method 1000 executable by a given electronic device. Various steps of the method 1000 will now be described

At step 1002, the electronic device is configured to monitor proximity between the first device (e.g., the electronic device) and the second device (e.g., another electronic device) using a proximity sensor.

In some embodiments, the proximity sensor of the step 1002 may be a light sensor of at least one of the first device and the second device. In other embodiments, the proximity sensor of the step 1002 may be a magnetic sensor of at least one of the first device and the second device.

In some embodiments, at least one of the first device and a second device may be a smartphone. In other embodiments, the other one of the first device and the second device may be a smartspeaker.

At step 1004, the electronic device is configured to trigger, based on information received from the proximity sensor, use of communication hardware to detect proximity between the first device and the second device, the communication hardware having a comparatively higher power consumption to the proximity sensor.

In some embodiments, during the step 1004, the electronic device may be configured to trigger wireless communication using at least one of a first wireless protocol and a second wireless protocol.

In some embodiments, the communication hardware may comprise Bluetooth-based hardware of at least one of the first device and the second device. In other embodiments, the communication hardware may comprise Near Field Communication (NFC) hardware of at least one of the first device and the second device.

At step 1006, the electronic device is configured to in response to detecting proximity using the communication hardware, establish a connection between the first device and the second device.

In some embodiments, the electronic device may be configured to trigger transmission of data from one of the first device (e.g., the electronic device) and the second device (e.g., the other electronic device) to the other one of the first device and the second device. It is contemplated that the data may comprise at least one of textual data, audio data, and video data, without departing from the scope of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method for proximity-based collaboration between a first device and a second device, the method comprising:
monitoring proximity between the first device and the second device using a proximity sensor;
triggering, based on information received from the proximity sensor, use of communication hardware to detect proximity between the first device and the second device, the communication hardware having a comparatively higher power consumption to the proximity sensor; and
in response to detecting proximity using the communication hardware, establishing a connection between the first device and the second device.

2. The method of claim 1, wherein the proximity sensor is a light sensor of at least one of the first device and the second device.

3. The method of claim 1, wherein the first proximity sensor is a magnetic sensor of at least one of the first device and the second device.

4. The method of claim 1, wherein the triggering the use of the communication hardware comprises triggering wireless communication using at least one of a first wireless protocol and a second wireless protocol.

5. The method of claim 1, wherein the communication hardware comprises Bluetooth-based hardware of at least one of the first device and the second device.

6. The method of claim 1, wherein the communication hardware comprises Near Field Communication (NFC) hardware of at least one of the first device and the second device.

7. The method of claim 1, wherein at least one of the first device and a second device is a smartphone.

8. The method of claim 7, wherein the other one of the first device and the second device is a smartspeaker.

9. The method of claim 1, wherein the method further comprises triggering transmission of data from one of the first device and the second device to the other one of the first device and the second device.

10. The method of claim 9, wherein the data is at least one of textual data, audio data, and video data.

11. An electronic device comprising a processor, a proximity sensor and communication hardware, the processor being configured to:
monitor proximity between the electronic device and an other electronic device using the proximity sensor;
trigger, based on information received from the proximity sensor, use of the communication hardware to detect proximity between the electronic device and the other electronic device, the communication hardware having a comparatively higher power consumption to the proximity sensor; and
in response to detecting proximity using the communication hardware, establishing a connection between the first device and the second device.

12. The electronic device of claim 11, wherein the proximity sensor is a light sensor.

13. The electronic device of claim 11, wherein the proximity sensor is a magnetic sensor.

14. The electronic device of claim 11, wherein to trigger the use of the communication hardware comprises the processor configured to trigger wireless communication between the electronic device and the other electronic device using at least one of a first wireless protocol and a second wireless protocol.

15. The electronic device of claim 11, wherein the communication hardware comprises Bluetooth-based hardware.

16. The electronic device of claim 11, wherein the communication hardware comprises Near Field Communication (NFC) hardware.

17. The electronic device of claim 11, wherein the electronic device is a smartphone.

18. The electronic device of claim 17, wherein the other electronic device is a smartspeaker.

19. The electronic device of claim 11, wherein the processor is further configured to trigger transmission of data from one of the electronic device and the other electronic device to the other one of the electronic device and the other electronic device.

20. A non-transient computer readable medium containing program instructions for causing an electronic device to perform a method of:
monitoring proximity between the electronic device and an other electronic device using a proximity sensor;
triggering, based on information received from the proximity sensor, use of communication hardware to detect proximity between the electronic device and the other electronic device, the communication hardware having a comparatively higher power consumption to the proximity sensor; and
in response to detecting proximity using the communication hardware, establishing a connection between the electronic device and the other electronic device.
